(19) United States
(12) Patent Application Publication
(10) Pub. No.: US 2021/0373492 A1
(43) Pub. Date: Dec. 2, 2021

(54) Laminated Holographic Display and Manufacturing Thereof

(71) Applicant: WAYRAY SA, Lausanne (CH)

(72) Inventors: Vera Ya. Popkova, Moscow (RU); Sergey V. Valgin, Vladimir (RU); Vladimir G. Zhigalov, Vladimir (RU); Vitaly A. Ponomarev, Menzingen (CH)

(21) Appl. No.: 17/399,443

(22) Filed: Aug. 11, 2021

Related U.S. Application Data
(63) Continuation of application No. 16/127,881, filed on Sep. 11, 2018.

(30) Foreign Application Priority Data
Sep. 29, 2017 (EP) EP17194079.4

(51) Int. Cl. G03H 1/02; B32B 17/10; G02B 5/32; G02B 27/01

(52) U.S. Cl. CPC G03H 1/024; B32B 17/10761; B32B 17/1077; B32B 17/10788; G02B 27/0103; B32B 17/10779; B32B 17/10706; B32B 17/10036; G02B 5/32; B32B 17/10724

(57) ABSTRACT

The present disclosure refers to a method for producing a laminated holographic display comprising the following steps; providing a display precursor, wherein the display precursor comprises a first glass layer, a second glass layer, an unrecorded photopolymer film layer, which is arranged between the first glass layer and the second glass layer, and a polymer film layer, which is arranged between the unrecorded photopolymer film layer and the second glass layer, wherein the providing step is performed in the absence of ambient light; laminating the display precursor to obtain a display laminate, wherein the laminating step is performed in the absence of ambient light; and recording a hologram in the display laminate by applying a light beam to the unrecorded photopolymer film layer of the display laminate to obtain a recorded photopolymer film layer comprising the hologram, wherein the recording step is performed in the absence of ambient light.

### CROSS-REFERENCE TO RELATED APPLICATION(S)

This application claims the benefit of European Patent Application No. EP17194079.4, filed Sep. 29, 2017, the entirety of which is hereby incorporated herein by reference.

This application is a continuation of and claims the benefit of U.S. patent application Ser. No. 16/127,881, filed Sep. 11, 2018, the entirety of which is hereby incorporated herein by reference.

### BACKGROUND OF THE INVENTION

### 1. Field of the Invention

The present disclosure relates to a laminated holographic display and to a method of producing a laminated holographic display, wherein the laminated holographic display in particular is integrated in a windshield, in a head-up display (HUD), in a smart glass (SG) or in an augmented reality (AR) system.

### 2. Description of the Related Art

A holographic display is commonly used in a variety of applications, and may be integrated in a windshield, in particular in a vehicle, airplane or boat windshield, in a head-up display (HUD), in a smart glass (SG) or in an augmented reality (AR) system. A holographic display is designed to display a hologram, which can be seen by the operator of the holographic display in a three-dimensional shape. The hologram, which is displayed by the holographic display, provides a plurality of information, which can be effectively perceived by the operator within his field of view. Therefore, the operator does not have to turn his head to monitor various control elements during operation of the vehicle, airplane or boat.

In U.S. Pat. No. 5,335,099 A, a vehicle windshield with a zero-degree mirror reflection hologram is disclosed. The windshield includes an inner glass layer, a zero-degree mirror hologram layer directly attached to the inner glass layer, an optical adhesive layer, a PVB layer and an outer glass layer.

In U.S. Pat. No. 5,859,714 A, a head-up display for displaying driving information to an operator in a vehicle, a combiner used for the same and a method of designing the head-up display is disclosed. The windshield comprises a reflection type hologram directly attached to a cabin side glass, and comprises an outside glass, together with an inner layer composed of PVB to form a safety laminated glass.

In US 2015/0138627 A1, a projection or back-projection method is disclosed, according to which a glazing comprising a transparent layered element having diffuse reflection properties is used as projection or back-projection screen. The glazing comprises the following stack, a lower rough glass layer, a central steel layer, an upper sol-gel layer, a thermo-formable plastic layer, a light-scattering system comprising a functional film, an upper additional layer, another top glass layer.

In EP 0 407 772 B1, a process for altering the wavelength response of a volume phase hologram is disclosed. A photopolymerizable layer is mounted on a glass plate and is protected by a polyethylene terephthalate film support, wherein the film element can comprise a polymeric binder selected from PVB.

In EP 2 848 595 A1, a laminated glass used in the windshields of cars is disclosed. The laminated glass includes at least two sheets of glass plates laminated together with an intermediate layer disposed there between, wherein the intermediate layer is formed by sandwiching an optical film containing an infrared reflecting layer on a transparent film between two sheets of intermediate films containing a thermoplastic resin.

However, such holographic displays have to be integrated into glass structures to be available to the operators, and therefore laminated holographic displays have to be manufactured. However, when manufacturing laminated holographic displays, the optical properties of the hologram, such as a hologram resolution, hologram diffraction efficiency and/or hologram color, can be adversely affected during the lamination process (see, for example J. Opt. 29 (1998) 95-103; U.S. Pat. No. 9,261,778 B2).

### SUMMARY OF THE INVENTION

It is therefore an object of the present disclosure to provide laminated holographic displays, which are configured to display holograms with advantageous optical properties.

This object is achieved by way of the features of the independent patent claims. Advantageous developments are the subject matter of the dependent claims, the description and the appended figures.

The present disclosure is based on the finding that the above object can be achieved by performing the providing step and the lamination step during manufacturing of the laminated holographic display in the absence of ambient light. During production of the laminated holographic displays, the optical properties of the holograms displayed by said displays can be significantly improved when the providing step and the lamination step, which are performed before recording the hologram, are performed in the absence of ambient light.

According to a first aspect, the present disclosure relates to a method for producing a laminated holographic display comprising the following steps; providing a display precursor, wherein the display precursor comprises a first glass layer, a second glass layer, an unrecorded photopolymer film layer, which is arranged between the first glass layer and the second glass layer, and a polymer film layer, which is arranged between the unrecorded photopolymer film layer and the second glass layer, wherein the providing step is performed in the absence of ambient light; laminating the display precursor to obtain a display laminate, wherein the laminating step is performed in the absence of ambient light; and recording a hologram in the display laminate by applying a light beam to the unrecorded photopolymer film layer of the display laminate to obtain a recorded photopolymer film layer comprising the hologram, wherein the recording step is performed in the absence of ambient light.

As a result of the method according to the present disclosure, a laminated holographic display can be produced, wherein the hologram displayed by the recorded photopolymer film layer exhibits superior optical properties, such as high optical resolution, advanced optical diffraction properties, defined wavelength, true color properties and/or the absence of an “orange peel” effect in the hologram.

During conventional lamination processes performed during the manufacture of conventional laminated holographic displays, lamination is typically performed after recording of the hologram. Therefore, due to the high pressure and elevated temperature occurring during the lamination and diffusion processes, the optical properties of the recorded hologram can be negatively affected.

Therefore, in the method according to the present disclosure, the lamination step is performed before recording of the hologram in the photopolymer film layer, so that the conditions during the lamination step have no effect on the hologram itself. However, to protect the unrecorded photopolymer film layer during the lamination process, the providing and lamination steps are performed in the absence of ambient light. Thereby, it is ensured that a superior hologram can be recorded in the unrecorded photopolymer film layer during the recording step, which is performed after the lamination step.

The recording of the hologram is also performed in the absence of ambient light, by applying a light beam to the unrecorded photopolymer film layer of the display laminate after the lamination step, resulting in the formation of the hologram within the recorded photopolymer film layer.

The light beam can be a laser light beam, emitting coherent and monochromatic laser light when recording the hologram. The absence of ambient light during recording of the hologram is important to ensure that the interference pattern, which is recorded in the photopolymer film layer, only comprises wave information, which is derived from the object, the hologram is based on, and to ensure that no unrelated wave information is integrated into the interference pattern, thereby ensuring the optical quality of the hologram.

In particular during the recording step of the hologram, the coherent and monochromatic laser beam is split into an illumination beam and a reference beam by a beam splitter. The reference beam is directly applied to the unrecorded photopolymer film layer. The illumination beam is applied to the object, the hologram is based on. The illumination beam interacts with the object, thereby generating an object beam, which in turn is also applied to the unrecorded photopolymer film layer. By applying two light beams, namely the reference beam and the object beam, to the unrecorded photopolymer film layer an interference pattern can be recorded, which is correlated to the hologram, which should be displayed by the holographic display.

According to one embodiment, the laminating step is performed at a temperature from 50° C. to 130° C. and/or a pressure from 1 bar to 16 bar, and wherein the laminating step is preferably performed in an autoclave.

As a result, the temperature and pressure ranges, which can be effectively provided in an autoclave, ensure a proper lamination of the different layers of the display precursor during the lamination process.

According to one embodiment, the display precursor comprises an optically transparent adhesive layer, which is arranged between the photopolymer film layer and the first glass layer, wherein the optically transparent adhesive layer preferably comprises silicone-based adhesive, and wherein the thickness of the optically transparent adhesive layer is more preferably from 20 μm to 50 μm.

As a result, the optically transparent adhesive layer ensures a stable connection between the photopolymer film layer and the first glass layer. Due to the optically transparent properties of the optically transparent adhesive layer, light can pass through the adhesive layer, thereby enabling a proper recording or viewing of the hologram.

According to one embodiment, the display precursor comprises an additional polymer film layer, which is arranged between the photopolymer film layer and the first glass layer. The additional polymer film layer may be an adhesive layer.

As a result, beside the polymer film layer, which is arranged between the photopolymer film layer and the second glass layer, the additional polymer film layer, arranged between the photopolymer film layer and the first glass layer, effectively enclose the photopolymer film layer, thereby protecting the photopolymer film layer from chemical and mechanical damage.

According to one embodiment, the at least one polymer film layer comprises polyvinyl butyral (PVB), ethylene vinyl acetate (EVA) and/or polyurethane (PU), wherein the thickness of the at least one polymer film layer is preferably from 380 μm to 1500 μm, more preferably from 380 μm to 760 μm.

As a result, polyvinyl butyral, ethylene vinyl acetate and/or polyurethane ensure efficient mechanical and chemical properties of the polymer film layer and/or of the additional polymer film layer. In particular, polyvinyl butyral, ethylene vinyl acetate and/or polyurethane can display optically transparent properties, so that light can pass through the polymer film layers thereby enabling a proper recording or viewing of the hologram.

According to one embodiment, the photopolymer film layer comprises a photopolymer film and a substrate layer, wherein the substrate layer is arranged between the polymer film layer and the photopolymer film.

As a result, the substrate layer of the photopolymer film layer ensures that the photopolymer film is effectively embedded within the photopolymer film layer.

According to one embodiment, the photopolymer film layer comprises an additional substrate layer, wherein the additional substrate layer is arranged between the photopolymer film and the additional polymer layer.

As a result, the photopolymer film is effectively enclosed within the photopolymer film layer. The substrate layer is arranged between the photopolymer film and the polymer layer, and the additional substrate layer is arranged between the photopolymer film and the additional polymer layer.

According to one embodiment, the substrate layer and/or additional substrate layer comprise polyamide (PA), cellulose triacetate (TAC) and/or polyethylene terephthalate (PET), preferably polyamide (PA), and the photopolymer film preferably comprises cross-linked polyurethane (PU).

As a result, the polyamide, cellulose triacetate and/or polyethylene terephthalate layers provide an efficient stabilization of the photopolymer film. When the photopolymer film comprises cross-linked polyurethane, an efficient recording of an interference pattern in the photopolymer film can be ensured. Preferably, the photopolymer film is a Bayfor® HX photopolymer film.

According to one embodiment, the thickness of the substrate layer and/or the additional substrate layer is from 35 μm to 60 μm, preferably 60 μm, and/or the thickness of the photopolymer film is from 8 μm to 18 μm, preferably 15 μm.

As a result, the claimed substrate thickness and claimed photopolymer film thickness allow for an efficient recording of the hologram in the photopolymer film, while also ensuring mechanical stability of the photopolymer film layer.

According to one embodiment, the laminated holographic display is integrated in a windshield, preferably vehicle, aircraft or boat windshield, in a head-up display (HUD), preferably vehicle, aircraft or boat head up display (HUD), a smart glass (SG) or in an augmented reality (AR) system.

As a result, the laminated holographic display can be effectively used in a variety of applications to instantly and simply provide information to the operator of the laminated holographic display.

According to one embodiment, the laminating step is performed in an autoclave, wherein the method comprises the additional method step, darkening the interior of the autoclave before the laminating step to perform the laminating step in the absence of ambient light.

As a result, by effectively darkening the interior of the autoclave before the lamination step, it can be prevented that ambient light originating from the exterior of the autoclave enters the interior of the autoclave during the lamination step. In particular, the darkening of the interior of the autoclave can include sealing off any openings in the autoclave body, through which ambient light could enter the interior of the autoclave. Alternatively or additionally, darkening of the interior of the autoclave can also include switching off any ambient light sources in proximity to the autoclave, for example to switch off all external lights in the room, wherein the autoclave is present.

According to one embodiment, during the lamination step the illuminance of ambient light at the display precursor is below 0.5 lux, preferably below 0.05 lux, more preferably below 0.005 lux and/or during the recording step the illuminance of ambient light at the display laminate is below 0.5 lux, preferably below 0.05 lux, more preferably below 0.005 lux.

As a result, the reduced illuminance of ambient light at the display precursor during the lamination step and/or the reduced illuminance of ambient light at the display laminate during the recording step protect the photopolymer film from being altered. This allows for an efficient recording of the hologram in the photopolymer film during the recording step, since the illuminance of ambient light, measured at the display laminate is sufficiently low to prevent any alteration of the optical properties of the hologram to be recorded.

According to one embodiment, the method comprises an additional method step, applying a first coating on an external surface of the first glass layer and/or applying a second coating on an external surface of the second glass layer, wherein the additional method step is performed after the recording step, wherein the first coating and/or second coating preferably comprises polyethylene terephthalate (PET) and/or polycarbonate (PC), wherein the first coating and/or second coating more preferably is applied during a lamination procedure at a temperature from 10° C. to 130° C. in an autoclave or wherein the first coating and/or second coating more preferably is applied during a lamination procedure at a temperature from 10° C. to 50° C. without an autoclave.

As a result, the first and/or second coating applied to the external surface of the first and/or second glass layer protect said glass layers from mechanical and chemical damage. During the lamination procedure, the laminated holographic display, comprising the hologram recorded in the photopolymer film layer, is laminated again in an autoclave at a temperature from 10° C. to 130° C., or is laminated without an autoclave at a temperature from 10° C. to 50° C. depending on the coating materials, wherein the recorded hologram is not damaged during said subsequent lamination procedure.

According to a second aspect, the present disclosure relates to a laminated holographic display obtainable by a method according to the first aspect.

As a result, the laminated holographic display displaying the hologram comprises efficient optical properties for the operator to perceive the hologram.

The subject matter of the embodiments related to the method for producing a laminated holographic display according to the first aspect of the present disclosure should be herewith also included as embodiments related to the laminated holographic display obtainable by a method according to the second aspect.

According to a third aspect, the present disclosure relates to a laminated holographic display comprising; a first glass layer; a second glass layer; a recorded photopolymer film layer comprising a hologram, wherein the recorded photopolymer film layer is arranged between the first glass layer and the second glass layer; a polymer film layer, which is arranged between the recorded photopolymer film layer and the second glass layer; and an additional film layer, which is arranged between the recorded photopolymer film layer and the first glass layer.

As a result, the laminated holographic display displaying the hologram comprises efficient optical properties for the operator to perceive the hologram.

The subject matter of the embodiments related to the method for producing a laminated holographic display according to the first aspect of the present disclosure should be herewith also included as embodiments related to the laminated holographic display according to the third aspect.

According to one embodiment the additional film layer is an optically transparent adhesive layer, preferably a silicone-based optically transparent adhesive layer or an additional polymer film layer, preferably comprising polyvinyl butyral (PVB), ethylene vinyl acetate (EVA) and/or polyurethane (PU).

As a result, the additional film layer being either an optically transparent adhesive layer or an additional polymer film layer allows for an efficient manufacture of the laminated holographic display.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

Further embodiments of the principles and techniques of that disclosure are explained in greater detail with reference to the appended drawings, in which:

FIG. 1 shows a schematic representation of a laminated holographic display in a vehicle windshield;

FIG. 2 shows a schematic representation of a laminated holographic display according to a first embodiment;

FIG. 3 shows a schematic representation of a laminated holographic display according to a second embodiment; and

FIG. 4 shows a schematic representation of a method for producing a laminated holographic display according to the first or second embodiment.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

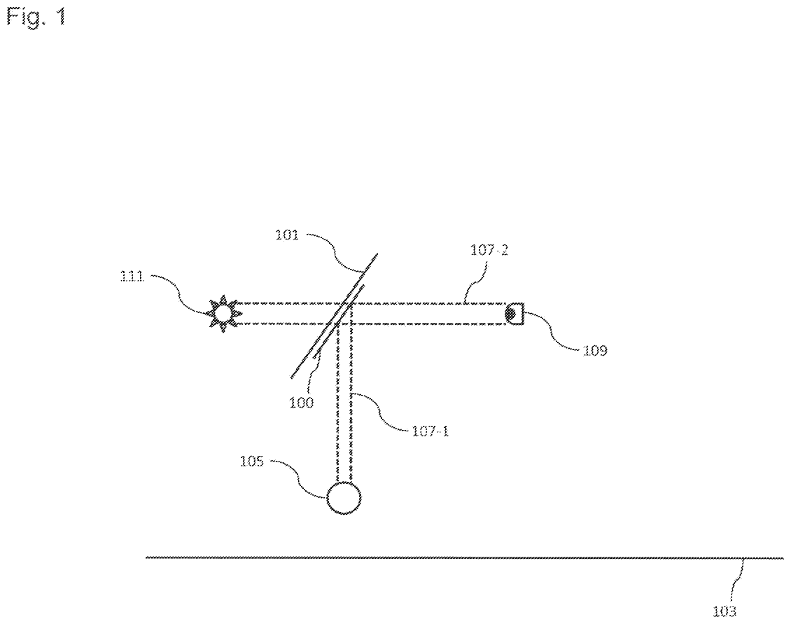

FIG. 1 shows a schematic representation of a laminated holographic display in a vehicle windshield.

The integration of holograms in glass and/or windshields enables the generation of holographic optical elements (HOE) for the use in smart glasses (SG), augmented reality (AR) systems and head-up displays (HUD) in vehicles, planes or boats.

The laminated holographic display 100 is integrated in a vehicle windshield 101 of a vehicle 103, e.g. an automobile, wherein the vehicle 103 is only schematically depicted in FIG. 1. A light element 105 emits light 107-1, which is diffracted by the laminated holographic display 100 to generate diffracted light 107-2 thereby generating a hologram 111, which is perceived by the operator 109 of the vehicle 103.

In particular, the light element 105 comprises a coherent light source to emit monochromatic light 107-1, a lens system used as a collimator and/or display components, such DLP, LCD and/or LCoS, to modify the optical properties of the light 107-1 emitted by the light element 105.

The light element 105 can be configured to comprise a laser generator emitting coherent and monochromatic laser light 107-1 or can be configured to comprise hot cathode ray tube to emit coherent and monochromatic light 107-1.

The laminated holographic display 100 is functioning as an optical element, such as a spherical mirror, at the desired wavelength and is configured to display a hologram 111 at a certain wavelength, while the laminated holographic display 100 is transparent to the rest of the visible spectrum of the emitted light 107-1.

When reconstructing the hologram 111 according to the embodiment depicted in FIG. 1, it is important that the optical properties of the light 107-1 emitted by the light element 105 are identical to the optical properties of the recording light, which was used when an interference pattern has been recorded in the laminated holographic display 100 before. The interference pattern is correlated to the hologram 111 displayed by the laminated holographic display 100.

Accordingly, coherent and monochromatic light 107-1 of said specific optical properties is directed to the laminated holographic display 100, wherein the light 107-1 is diffracted by the interference pattern, which has been recorded in the laminated holographic display 100, towards the operator 109 of the vehicle 103. The diffracted light 107-2 comprises the optical properties of the object, which was recorded in the laminated holographic display 100 thereby generating the hologram 111, which is perceived by the operator 109 in the windshield 101.

Since the interference pattern recorded in the laminated holographic display 100 also comprises optical information in respect to the space in front and behind the recorded object, the hologram 111 displayed by the laminated holographic display 100 can be viewed by the operator 109 from different angles thereby generating a three-dimensional impression of the hologram 111.

The laminated holographic display 100 is configured to display a color hologram 111 in particular a true color hologram 111. In particular, the laminated holographic display 100 is configured to display a plurality of holograms 111, wherein the plurality of holograms 111 can comprise different colors. According to FIG. 1, the hologram 111 displayed by the laminated holographic display 100 is a transmission hologram 111, however the scope of the present disclosure also comprises reflection holograms 111.

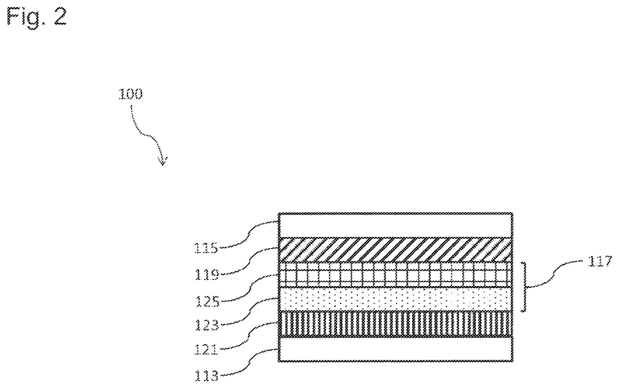

FIG. 2 shows a schematic representation of a laminated holographic display according to a first embodiment. The laminated holographic display 100 comprises a first glass layer 113 and a second glass layer 115, which delimit the laminated holographic display 100 from the exterior of the laminated holographic display 100.

Between the first and second glass layer 113, 115, a photopolymer film layer 117 is arranged. The photopolymer film layer 117 comprises an interference pattern, which is correlated to the object recorded in the laminated holographic display 100, thereby generating the hologram 111.

Between the photopolymer film layer 117 and the second glass layer 115, a polymer film layer 119 is arranged. The polymer film layer 119 comprises polyvinyl butyral (PVB), ethylene vinyl acetate (EVA) and/or polyurethane (PU). The thickness of the polymer film layer 119 is preferably from 380 μm to 1500 μm, more preferably from 380 μm to 760 μm.

Between the photopolymer film layer 117 and the first glass layer 113, an optically transparent adhesive layer 121 is arranged. The optically transparent adhesive layer 121 preferably comprises silicone-based adhesive. The thickness of the optically transparent adhesive layer 121 is more preferably from 20 μm to 50 μm.

The photopolymer film layer 117 comprises a photopolymer film 123, which displays the hologram 111 and a substrate layer 125, wherein the substrate layer 125 is arranged between the polymer film layer 119 and the photopolymer film 123.

In particular, the substrate layer 125 comprises polyamide (PA), cellulose triacetate (TAC) and/or polyethylene terephthalate (PET), preferably polyamide (PA). In particular, the thickness of the substrate layer 125 is from 35 μm to 60 μm, preferably 60 μm.

In particular the photopolymer film 123 comprises cross-linked polyurethane (PU) derivatives. In particular, the thickness of the photopolymer film 123 is from 8 μm to 18 μm, preferably 15 μm.

Summarizing, the 6-layered sandwiched structure of the laminated holographic display 100 according to the first embodiment comprises the following consecutive order of film layers: the first glass layer 113, the optically transparent adhesive layer 121, the photopolymer film 123, which displays the hologram 111, the substrate layer 125, the polymer film layer 119 and the second glass layer 115.

Even if not depicted in FIG. 2 a first coating can be applied on an external surface of the first glass layer 113 and/or a second coating can be applied on an external surface of the second glass layer 115. The first coating and/or second coating preferably comprise polyethylene terephthalate (PET) and/or polycarbonate (PC).

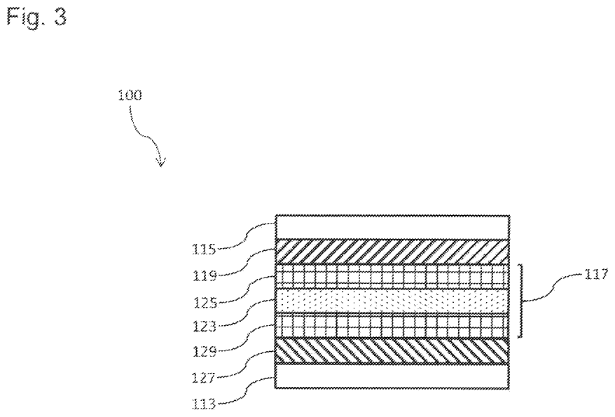

FIG. 3 shows a schematic representation of a laminated holographic display according to a second embodiment. Similar to the laminated holographic display 100 according to the first embodiment, the laminated holographic display 100 according to the second embodiment comprises a first glass layer 113 and a second glass layer 115, and a photopolymer film layer 117, which is arranged between the first and second glass layer 113, 115, wherein the photopolymer film layer 117 comprises an interference pattern, which is correlated to the object recorded in the laminated holographic display 100, thereby generating the hologram 111.

Between the photopolymer film layer 117 and the second glass layer 115, a polymer film layer 119 is arranged.

Instead of the optically transparent adhesive layer 121 in the laminated holographic display 100 according to the first embodiment, the laminated holographic display 100 according the second embodiment depicted in FIG. 2 comprises an additional polymer film layer 127, which is arranged between the photopolymer film layer 117 and the first glass layer 113.

An additional polymer film layer 127 comprises polyvinyl butyral (PVB), ethylene vinyl acetate (EVA) and/or polyurethane (PU). The thickness of the additional polymer film layer 127 is preferably from 380 μm to 1500 μm, more preferably from 380 μm to 760 μm.

The photopolymer film layer 117 comprises a photopolymer film 123, which displays the hologram 111. In particular the photopolymer film 123 comprises cross-linked polyurethane (PU) derivatives. In particular, the thickness of the photopolymer film 123 is from 8 μm to 18 μm, preferably 15 μm.

In addition to the substrate layer 125 in the laminated holographic display 100 according to the first embodiment, the laminated holographic display 100 according to the second embodiment depicted in FIG. 3 comprises an additional substrate layer 129, wherein the additional substrate layer 129 is arranged between the photopolymer film 123 and the additional polymer film layer 127.

In particular, the substrate layer 125 and the additional substrate layer 129 comprise polyamide (PA), cellulose triacetate (TAC) and/or polyethylene terephthalate (PET), preferably polyamide (PA). In particular, the thickness of the substrate layer 125 and the additional substrate layer 129 is from 35 μm to 60 μm, preferably 60 μm.

Summarizing, the 7-layered sandwiched structure of the laminated holographic display 100 according to the second embodiment comprises the following consecutive order of film layers: the first glass layer 113, the additional polymer film layer 127, the additional substrate layer 129, the photopolymer film 123, which displays the hologram 111, the substrate layer 125, the polymer film layer 119 and the second glass layer 115.

Even if not depicted in FIG. 3 a first coating can be applied on an external surface of the first glass layer 113 and/or a second coating can be applied on an external surface of the second glass layer 115. The first coating and/or second coating preferably comprise polyethylene terephthalate (PET) and/or polycarbonate (PC).

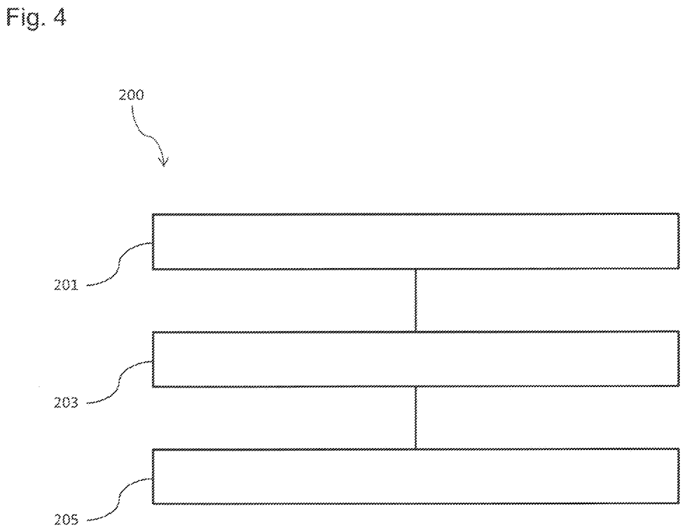

FIG. 4 shows a schematic representation of a method for producing a laminated holographic display according to the first embodiment depicted in FIG. 2 or according to the second embodiment depicted in FIG. 3.

Commonly used laminated holographic displays 100 are produced by providing a photopolymer film with the integrated hologram 111 together with additional film layers and subsequent lamination of the layers.

For commonly performed lamination processes, different polymeric materials are used, since holograms 111 are very sensitive to the process of diffusion and to process parameters such as high pressure and elevated temperature. During common processes of lamination, the optical properties of the hologram 111 can be diminished, which might result in a reduction of resolution and diffraction efficiency, as well as in a change in wavelength of the hologram 111.

To improve optical properties of holograms 111 used in laminated holographic displays 100, the method 200 for producing a laminated holographic display 100 according to the present disclosure comprises as a first method step, providing 201 a display precursor 100-1, wherein the providing step 201 is performed in the absence of ambient light. The display precursor 100-1 comprises various film layers as disclosed for the 6-layered structure according to the first embodiment depicted in FIG. 2, or as disclosed for the 7-layered structure according to the second embodiment depicted in FIG. 3.

It is emphasized that in the display precursor 100-1 the photopolymer film layer 117 comprises an unrecorded photopolymer film layer 117-1, wherein no hologram 111 has been recorded in the unrecorded photopolymer film layer 117-1.

The method 200 for producing a laminated holographic display 100 according to the present disclosure comprises as a subsequent second method step, laminating 203 the layers of the display precursor 100-1 to obtain a display laminate 100-2, wherein the laminating step 203 is performed in the absence of ambient light.

Due to the absence of ambient light during the lamination step 203 and also during the provision step 201, the chemical properties of the unrecorded photopolymer film layer 117-1 are maintained, which allows for a subsequent recording of a hologram 111 in the unrecorded photopolymer film layer 117-1, wherein the optical properties of the subsequently recorded hologram 111 are superior compared to a conventional lamination process of the recorded hologram performed in the presence of ambient light.

The lamination step is performed in an autoclave, preferably at a temperature from 50° C. to 130° C., and preferably at a pressure from 1 bar to 16 bar.

To prevent light from entering the interior of autoclave during the lamination step, the method 200 comprises the additional method step, darkening the interior of the autoclave before the lamination step. By darkening the interior of the autoclave it can be ensured that the lamination process is performed in the absence of ambient light. The darkening of the interior of the autoclave is performed by sealing off any openings in the autoclave body by non-light transparent means or by switching off any external light sources in the autoclave room.

Particularly, to perform the lamination step in the absence of ambient light according to the present disclosure, the illuminance of ambient light at the display precursor 100-1 during the lamination step is preferably below 0.5 lux, more preferably below 0.05 lux and most preferably below 0.005 lux.

The method 200 for producing a laminated holographic display 100 according to the present disclosure comprises as a subsequent third method step, recording 205 a hologram 111 in the unrecorded photopolymer film layer 117-1 of the display laminate 100-2 by applying a light beam to the unrecorded photopolymer film layer 117-1 to obtain the laminated holographic display 100 comprising the hologram 111.

To allow for a superior recording of the hologram 111, the recording step 205 is also performed in the absence of ambient light, wherein in particular the illuminance of ambient light at the display laminate 100-2 during the recording step 205 is preferably below 0.5 lux, more preferably below 0.05 lux and most preferably below 0.005 lux.

To avoid exposure of the unrecorded photopolymer film layer 117-1 to ambient light between the lamination step 203 and the recording step 205, transfer of the display laminate 100-2 from the autoclave to the recording device is preferably performed in darkness, preferably in a darkened room.

The method 200 for producing a laminated holographic display 100 according to the present disclosure enables a superior recording of the hologram 111 in the photopolymer film layer 117 of the laminated holographic display 100.

The optical properties of the hologram 111 in the laminated holographic display 100, in particular the resolution, diffraction efficiency and/or color of the hologram 111, can exceed the optical properties of commonly used laminated holographic displays 100. In particular, the optical properties of the hologram 111 can even exceed the optical properties of commonly used laminated holographic displays 100. In particular no orange peel can be observed in the laminated holographic display 100 according to the present disclosure.

Optionally, the method 200 comprises an additional method step, comprising; applying a first coating on an external surface of the first glass layer 113 and/or applying a second coating on an external surface of the second glass layer 115, wherein the additional method step is performed after the recording step 205, wherein the first coating and/or second coating preferably comprises polyethylene terephthalate (PET) and/or polycarbonate (PC). More preferably the first coating and/or second coating is applied during a lamination procedure at a temperature from 10° C. to 130° C. in an autoclave or at a temperature from 10° C. to 50° C. without an autoclave. It is emphasized that the recorded hologram 111 is not altered during said final lamination procedure.

While preferred embodiments of the disclosure have been described herein, many variations are possible which remain within the concept and scope of the disclosure. Such variations would become clear to one of ordinary skill in the art after inspection of the specification and the drawings. The disclosure therefore is not to be restricted except within the spirit and scope of any appended claims.

### REFERENCE NUMBERS

The following lists of reference numbers associated with the drawings in this disclosure:

100 Laminated holographic display

100-1 Display precursor

100-2 Laminated precursor

101 Windshield

103 Vehicle

105 Light element

107-1 Emitted light

107-2 Diffracted light

109 Operator

111 Hologram

113 First glass layer

115 Second glass layer

117 Photopolymer film layer

117-1 Unrecorded photopolymer film layer

117-2 Recorded photopolymer film layer

119 Polymer film layer

121 Optically transparent adhesive layer

123 Photopolymer film

125 Substrate layer

127 Additional polymer film layer

129 Additional substrate layer

200 Method for producing a laminated holographic display

201 First method step: Providing a display precursor

203 Second method step: Laminating the display precursor

205 First method step: Recording a hologram

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. 112(f) unless the words “means for” or “step for” are explicitly used in the particular claim. The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method for producing a laminated holographic display comprising the following steps:
providing a display precursor wherein the display precursor comprises a first glass layer a second glass layer an unrecorded photopolymer film layer, which is arranged between the first glass layer and the second glass layer and a polymer film layer, which is arranged between the unrecorded photopolymer film layer and the second glass layer wherein the providing step is performed in the absence of ambient light;
laminating the display precursor to obtain a display laminate, wherein the laminating step is performed in the absence of ambient light; and
recording a hologram in the display laminate by applying a light beam to the unrecorded photopolymer film layer of the display laminate to obtain a recorded photopolymer film layer comprising the hologram, wherein the recording step is performed in the absence of ambient light,
wherein the display precursor comprises a second polymer film layer or optically transparent adhesive layer, which is arranged between the photopolymer film layer and the first glass layer,
wherein the unrecorded photopolymer film layer comprises a photopolymer film and a substrate layer, wherein the substrate layer is arranged between the polymer film layer and the photopolymer film, and
wherein the substrate layer comprises polyamide (PA), cellulose triacetate (TAC) and/or polyethylene terephthalate (PET),
wherein the unrecorded photopolymer film layer comprises a second substrate layer, wherein the second substrate layer is arranged between the photopolymer film and the second polymer film or optically transparent adhesive layer, wherein the second substrate layer comprises polyamide (PA), cellulose triacetate (TAC) and/or polyethylene terephthalate (PET), and
wherein the thickness of the unrecorded photopolymer film layer is from 8 μm to 18 μm,
wherein the laminating step is performed in an autoclave, wherein the method comprises the additional method step, darkening the interior of the autoclave before the laminating step to perform the laminating step in the absence of ambient light, and
wherein the method comprises an additional method step, applying a first coating on an external surface of the first glass layer and/or applying a second coating on an external surface of the second glass layer, wherein the additional method step is performed after the recording step, wherein the first coating and/or second coating comprises polyethylene terephthalate (PET) and/or polycarbonate (PC).

2. The method according to claim 1, wherein the laminating step is performed at a temperature from 50° C. to 130° C. and/or a pressure from 1 bar to 16 bar, and wherein the laminating step is preferably performed in an autoclave.

3. The method according to claim 1, wherein the optically transparent adhesive layer comprises silicone-based adhesive.

4. The method according to claim 1, wherein the at least one polymer film layer comprises polyvinyl butyral (PVB), ethylene vinyl acetate (EVA) and/or polyurethane (PU), and wherein the thickness of the at least one polymer film layer is preferably from 380 μm to 1500 μm, more preferably from 380 μm to 760 μm.

5. The method according to claim 1, wherein the unrecorded photopolymer film layer comprises a second substrate layer, wherein the second substrate layer is arranged between the photopolymer film and the second polymer film layer.

6. The method according to claim 1, wherein the substrate layer and/or second substrate layer comprise polyamide (PA), cellulose triacetate (TAC) and/or polyethylene terephthalate (PET), preferably polyamide (PA), and wherein the photopolymer film preferably comprises cross-linked polyurethane (PU).

7. The method according to claim 1, wherein the thickness of the substrate layer and/or the second substrate layer is from 35 μm to 60 μm, preferably 60 μm, and/or wherein the thickness of the photopolymer film is from 8 μm to 18 μm, preferably 15 μm.

8. The method according to claim 1, wherein during the lamination step the illuminance of ambient light at the display precursor is below 0.5 lux, preferably below 0.05 lux, more preferably below 0.005 lux and/or wherein during the recording step the illuminance of ambient light at the display laminate is below 0.5 lux, preferably below 0.05 lux, more preferably below 0.005 lux.

9. The method according to claim 1, wherein the first coating and/or second coating preferably is applied during a lamination procedure at a temperature from 10° C. to 130° C. in an autoclave or wherein the first coating and/or second coating preferably is applied during a lamination procedure at a temperature from 10° C. to 50° C. without an autoclave.

10. The method according to claim 9, wherein the second film layer is an optically transparent adhesive layer, preferably a silicone-based optically transparent adhesive layer or a second polymer film layer, preferably comprising polyvinyl butyral (PVB), ethylene vinyl acetate (EVA) and/or polyurethane (PU).

11. A laminated holographic display comprising:
a first glass layer;
a second glass layer;
a recorded photopolymer film layer comprising a hologram
wherein the recorded photopolymer film layer is arranged between the first glass layer and the second glass layer,
a polymer film layer, which is arranged between the recorded photopolymer film layer and the second glass layer; and
an additional film layer, which is arranged between the recorded photopolymer film layer and the first glass layer,
wherein the recorded photopolymer film layer comprises a photopolymer film and a substrate layer, wherein the substrate layer is arranged between the polymer film layer and the photopolymer film, wherein the unrecorded photopolymer film layer comprises a photopolymer film and a substrate layer, wherein the substrate layer is arranged between the polymer film layer and the photopolymer film, and wherein the substrate layer comprises polyamide (PA), cellulose triacetate (TAC) and/or polyethylene terephthalate (PET),
wherein the unrecorded photopolymer film layer comprises a second substrate layer, wherein the second substrate layer is arranged between the photopolymer film and the second polymer film or optically transparent adhesive layer,
wherein the second substrate layer comprises polyamide (PA), cellulose triacetate (TAC) and/or polyethylene terephthalate (PET), and wherein the thickness of the unrecorded photopolymer film layer is from 8 μm to 18 μm, and
wherein an external surface of the first glass layer comprises a first coating and/or wherein an external surface of the second glass layer comprises a second coating, wherein the first coating and/or second coating comprises polyethylene terephthalate (PET) and/or polycarbonate (PC).
